(19) United States
(12) Patent Application Publication
(10) Pub. No.: US 2023/0223809 A1
(43) Pub. Date: Jul. 13, 2023

(54) OVER-MOLDED WINDINGS WITH INCORPORATED BUS BAR FOR MULTI-PHASE ELECTRIC MOTORS

(71) Applicant: SCHAEFFLER TECHNOLOGIES AG & CO. KG, Herzogenaurach (DE)

(72) Inventors: Michael Conner, Uniontown, OH (US); Zachary Gnabah, Canton, OH (US); Jeremy Vanni, Medina, OH (US)

(73) Assignee: SCHAEFFLER TECHNOLOGIES AG & CO. KG, Herzogenaurach (DE)

(21) Appl. No.: 17/574,404

(22) Filed: Jan. 12, 2022

(51) Int. Cl. H02K 3/52; H02K 15/00

(52) U.S. Cl. CPC H02K 3/522; H02K 15/0062; H02K 2203/09

(57) ABSTRACT

An apparatus and methods are provided for a segmented stator comprising over-molded windings and an incorporated bus bar for a multi-phase electric motor. The segmented stator comprises a plurality of stator segments that are arranged into a circular configuration. Each stator segment comprises a divided core that includes a core back portion and a core tooth portion. An insulator is disposed on at least the core tooth portion, and a winding of magnet wire is disposed on the insulator. An over-molded encapsulation is applied to fixate the divided core and the winding. A bus bar is incorporated into the stator segments and placed into electrical communication with the windings. The bus bar includes annular conductors that may be over-molded such that the bus bar is encapsulated within the segmented stator. Connectors coupled with the bus bar are configured for passing an electric current to the stator segments.

### FIELD

Embodiments of the present disclosure generally relate to electric motors. More specifically, embodiments of the disclosure relate to an apparatus and methods for segmented stators including over-molded windings and incorporated bus bars for multi-phase electric motors.

### BACKGROUND

A conventional brushless motor typically includes a stator that is centered on a central axis and comprises a plurality of axially laminated steel plates. The stator may include a core back having a circular shape that is centered on the central axis and teeth extending radially inward from an inner circular surface of the core back. The teeth generally are circumferentially spaced from one another. One or more insulators may be attached to each of the teeth and then a magnet wire wound around each of the teeth such that a coil having a multilayer structure of magnet wire is formed on each of the teeth. The brushless motor includes a bus bar having a connector to which the coils arranged on the stator are connected.

In an attempt to reduce mechanical vibrations, some electric motor embodiments include a relatively greater number of teeth comprising the stator. One approach to increasing the number of teeth of the stator is known as a “divided-core” manufacturing technique wherein a plurality of individual stator teeth are formed, and a coil of magnet wire is wound onto each of the teeth. Next, the individual stator teeth are circumferentially attached to one another to form a stator. Another approach is known as a “curving-core” manufacturing technique wherein the coils are wound onto teeth extending from an elongate core back having a substantially linear shape. The core back is then bent at predetermined positions so as to form a circular shape suitable for a stator.

In general, the magnet wire may be wound around each of the above-mentioned teeth separately. As such, each of the teeth may include two protruding wire-ends, a winding-starting end and a winding-terminating end. Thus, the bus bar generally includes twice as many terminals as the number of the teeth comprising the stator. A drawback to increasing the number of terminals arranged on the bus bar, however, is that the space between the terminals is reduced, thus increasing the difficulty associated with connecting the wires to the terminals. Therefore, there is a continual desire to improve manufacturability, eliminate components (e.g., the bus bar), and reduce costs associated with assembling electric motors, particularly in the automotive sector.

### SUMMARY

An apparatus and methods are provided for a segmented stator comprising over-molded windings and an incorporated bus bar for a multi-phase electric motor. The segmented stator comprises a plurality of stator segments that are arranged into a circular configuration. The circular configuration is fixated by way of a cylindrical portion comprising an injection-molded polymer. Each stator segment comprises a divided core that includes a core back portion and a core tooth portion. An insulator is disposed on at least the core tooth portion, and a winding of magnet wire is disposed on the insulator. An over-molded encapsulation is applied to fixate the divided core and the winding. A bus bar is incorporated into the stator segments and placed into electrical communication with the windings. The bus bar includes annular conductors that may be over-molded such that the bus bar is encapsulated within the segmented stator. Connectors coupled with the bus bar are configured for passing an electric current to the stator segments.

In an exemplary embodiment, a segmented stator for a multi-phase electric motor comprises: a plurality of stator segments that are arranged into a circular configuration; a cylindrical portion that fixates the circular configuration; a bus bar incorporated into the stator segments; and connectors coupled with the bus bar for passing an electric current to the stator segments.

In another exemplary embodiment, the cylindrical portion comprises an injection-molded polymer that is applied to retain the circular configuration of the plurality of stator segments. In another exemplary embodiment, each of the plurality of stator segment comprises: a divided core that includes a core back portion and a core tooth portion; an insulator disposed on at least the core tooth portion; a winding of magnet wire disposed on the insulator; and an over-molded encapsulation of the divided core and the winding. In another exemplary embodiment, the divided core comprises a solid piece of magnetically permeable material, such as iron, steel, or other ferrous materials, without limitation. In another exemplary embodiment, the divided core comprises a plurality of laminated steel plates that are held together by way of the insulator. In another exemplary embodiment, the insulator comprises an over-molding that fixates the plurality of laminated steel plates in the form of the divided core. In another exemplary embodiment, the insulator comprises any suitable polymer that may be injection-molded around the section of the core tooth portion that receives the winding.

In another exemplary embodiment, the over-molded encapsulation is configured to cover and fixate primarily the winding and allow a winding start end and a winding terminal end to protrude from the stator segment. In another exemplary embodiment, the over-molded encapsulation includes raised ribs that are injection molded into the stator segment to define multiple channels so as to facilitate placing the winding into electrical communication with a bus bar. In another exemplary embodiment, the multiple channels are configured to form circular recesses when a plurality of stator segments are assembled into a circular configuration. In another exemplary embodiment, the circular recesses are configured to receive annular conductors comprising the bus bar. In another exemplary embodiment, the bus bar includes connectors whereby electric current may be conducted to the windings by way of the annular conductors. In another exemplary embodiment, the annular conductors are over-molded within the circular recesses such that the bus bar is encapsulated within the segmented stator.

In an exemplary embodiment, a stator segment for a multi-phase electric motor comprises: a divided core that includes a core back portion and a core tooth portion; an insulator disposed on at least the core tooth portion; a winding of magnet wire disposed on the insulator; and an over-molded encapsulation of the divided core and the winding.

In another exemplary embodiment, the insulator comprises an over-molding that fixates a plurality of laminated steel plates comprising the divided core. In another exemplary embodiment, the over-molded encapsulation is configured to fixate the winding and form raised ribs that define multiple channels for placing a bus bar into electrical communication with the winding.

In an exemplary embodiment, a method for a segmented stator for a multi-phase electric motor comprises: forming a plurality of stator segments; arranging the plurality of stator segments into a circular configuration; fixating the circular configuration by way of a cylindrical portion; placing a bus bar into electrical communication with the plurality of stator segments; incorporating the bus bar into the circular configuration; and coupling connectors with the bus bar for passing an electric current to the stator segments.

In another exemplary embodiment, forming the plurality of stator segment comprises: forming a divided core that includes a core back portion and a core tooth portion; disposing an insulator on at least the core tooth portion; disposing a winding of magnet wire on the insulator; and encapsulating the divided core and the winding. In another exemplary embodiment, disposing the insulator includes injection molding an over-molding that fixates a plurality of laminated steel plates comprising the divided core. In another exemplary embodiment, encapsulating the divided core and the winding includes injection molding an over-molded encapsulation to fixate the winding and form raised ribs that define multiple channels for placing a bus bar into electrical communication with the winding.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of a segmented stator that includes over-molded windings with an incorporated bus bar, according to the present disclosure;

FIG. 2 illustrates a perspective view of an exemplary embodiment of a wound core segment, according to the present disclosure;

FIG. 3 illustrates a perspective view of an exemplary embodiment of a stator segment that is formed by encapsulating the wound core segment of FIG. 2 in accordance with the present disclosure;

FIG. 4 illustrates a close-up perspective view of an exemplary embodiment of channels comprising the stator segment of FIG. 3 in accordance with the present disclosure;

FIG. 5 illustrates a perspective view of an exemplary embodiment of a segmented stator that may be formed by assembling a plurality of individual stator segments, according to the present disclosure;

FIG. 6 illustrates a perspective view of an exemplary embodiment of a bus bar that may be coupled with the segmented stator of FIG. 5 to form the segmented stator shown in FIG. 1; and

FIG. 7 is a flow chart illustrating an exemplary embodiment of a method for a segmented stator, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first connector,” may be made. However, the specific numeric reference should not be interpreted as a literal sequential order but rather interpreted that the “first connector” is different than a “second connector.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, a conventional brushless motor may be formed by a divided-core manufacturing technique that comprises forming a plurality of individual stator teeth and winding a coil of magnet wire onto each of the teeth before assembling the wound teeth into a circular stator. The magnet wire may be wound around each of the teeth separately, and thus each of the teeth includes two protruding wire-ends that are to be connected to terminals on a bus bar. A drawback to increasing the number of terminals arranged on the bus bar is that the space between the terminals is reduced, thus increasing the difficulty associated with connecting the wires to the terminals. There is a continual desire, therefore, to improve manufacturability, eliminate components, and reduce costs associated with assembling electric motors, particularly in the automotive sector. Embodiments presented herein provide segmented stators and methods for over-molding windings and incorporating bus bars comprising electric motors.

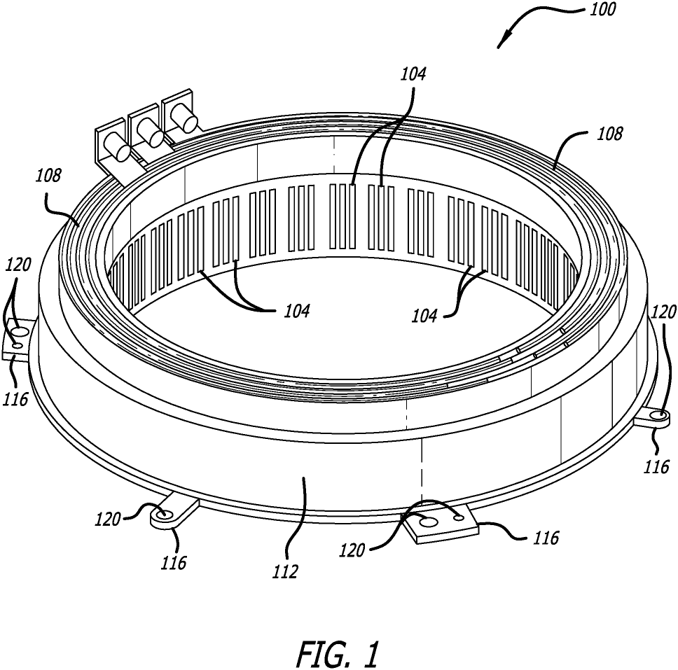

FIG. 1 illustrates a perspective view of an exemplary embodiment of a segmented stator 100 that may be implemented in a multi-phase electric motor, such as, for example, a three-phase electric motor. The segmented stator 100 includes over-molded stator segments 104 and an incorporated bus bar 108, according to the present disclosure. The stator segments 104 are of a divided-core variety of stator windings and are arranged into a circular configuration suitable for operating as a stator of an electric motor. The circular configuration of the stator segments 104 is retained by an exterior cylindrical portion 112. In some embodiments, the cylindrical portion 112 may comprise an injection-molded polymer that fixates the stator segments 104 in the circular configuration. In some embodiments, the cylindrical portion 112 may be configured to conduct a cooling fluid around the stator segments 104. For example, the cylindrical portion 112 may, in some embodiments, include a water jacket configured to conduct heat away from the stator segments 104. Further, the cylindrical portion 112 is provided with a plurality of mounting lugs 116 that are disposed at intervals along a circumferential direction and protrude along a radial direction with respect to the cylindrical portion 112. The mounting lugs 116 include mounting holes 120 for mounting the segmented stator 100 to a base (not shown) of an electric motor.

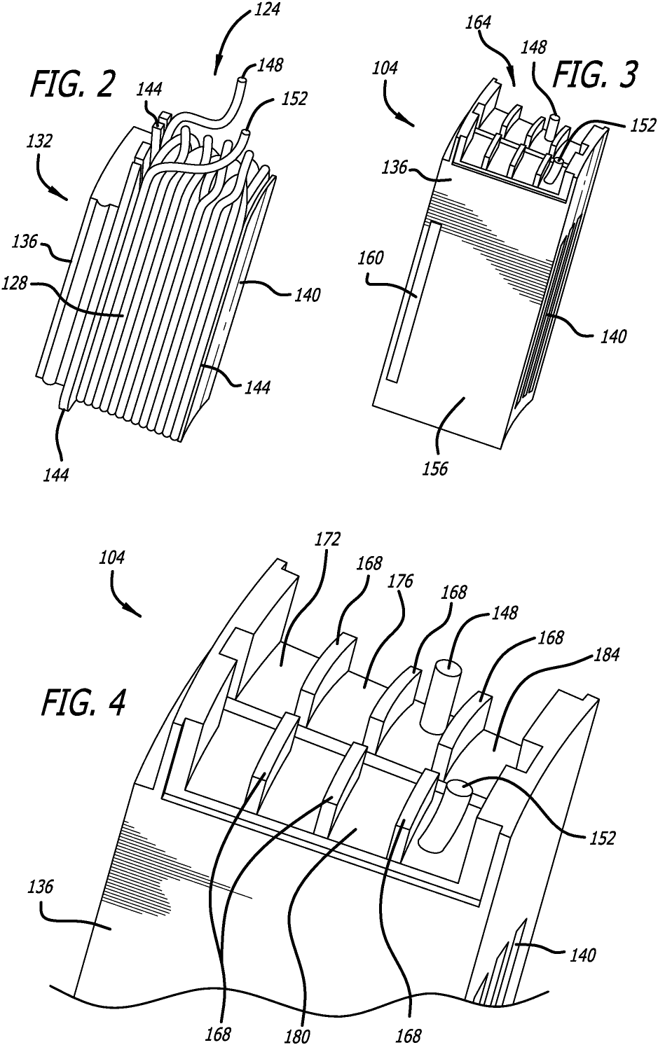

FIG. 2 illustrates a perspective view of an exemplary embodiment of a wound core segment 124 comprising the segmented stator 100, according to the present disclosure. The wound core segment 124 includes a winding 128 of magnet wire that is wound in a multilayer configuration onto a divided core 132. The divided core 132 includes a core back portion 136 and a core tooth portion 140 that extends through the winding 128. The core back portion 136 preferably includes a curvature that is radially convex, and the core tooth portion 140 includes a curvature that is radially concave. As will be appreciated, the convex curvature of the core back portion 136 facilitates arranging a plurality of divided cores 132 into a circular configuration to form a stator 100 having a substantially round circumference. Further, the concave curvature of the core tooth portions 140 generally is configured to minimize the clearance between the core tooth portions 140 and a rotor (not shown) comprising the electric motor.

It should be borne in mind that any number of stator segments 104 may be assembled to form a desired segmented stator 100, without limitation. For example, in one embodiment, a three-phase electric motor may include a segmented stator 100 that comprises 18 stator segments 104, such that each phase includes 6 stator segments 104. In another embodiment of a three-phase electric motor, a segmented stator 100 comprises 27 stator segments 104 arranged such that each phase includes 9 stator segments 104. In still another embodiment of a three-phase electric motor, a segmented stator 100 includes 33 stator segments 104 that are arranged such that each phase comprises 11 stator segments 104. Further, in still another embodiment of a three-phase electric motor, a segmented stator 100 includes 36 stator segments 104 that are arranged such that each phase comprises 12 stator segments 104. Thus, it is contemplated that the segmented stator 100 may comprise any number of stator segments 104 that may be arranged into any number of phases and incorporated into any of various multi-phase electric motor configurations, without limitation, and without straying beyond the spirit and scope of the present disclosure.

In some embodiments, the divided core 132 comprises a solid piece of magnetically permeable material, such as iron, steel, or other ferrous materials, without limitation. In some embodiments, the divided core 132 comprises a plurality of laminated steel plates that may be held together by way of an insulator 144. It is contemplated that, in some embodiments, the insulator 144 may comprise an over-molding that fixates the laminated steel plates in the form of the divided core 132. In such embodiments, the insulator 144 may comprise any suitable polymer that may be injection-molded around the section of the core tooth portion 140 that receives the winding 128, as shown in FIG. 2. For example, in some embodiments, the polymer includes a plastic, such as a polyamide (PA), polyphenylene sulfide (PPS), polyetheretherketone (PEEK), polyethetherketone (PEK), and the like, without limitation. Moreover, the magnet wire comprising the winding 128 preferably is wound onto the core tooth portion 140 in the form of a single piece of wire. Thus, a winding start end 148 and a winding terminal end 152 protrude from the wound core segment 124, as shown in FIG. 2. The start and terminal ends 148, 152 facilitate placing the winding 128 into electrical communication with the bus bar 108, as described herein.

FIG. 3 illustrates a perspective view of an exemplary embodiment of a stator segment 104 that may be formed by over-molding, or encapsulating, the wound core segment 124 of FIG. 2 in accordance with the present disclosure. As such, the stator segment 104 comprises an over-molded encapsulation 156 that is inj ection-molded over the wound core segment 124 shown is FIG. 2. As shown in FIG. 3, the over-molded encapsulation 156 may be configured to cover and fixate primarily the winding 128 and allow the start and terminal ends 148, 152 to protrude from the stator segment 104. Further, core side portions 160 of the core back portion 136 and the core tooth portion 140 may remain uncovered by the over-molded encapsulation 156. It is contemplated that the core side portions 160 may be configured to engage with the core side portions 160 of adjacent stator segments 104 comprising the stator 100 of FIG. 1. As such, the core side portions 160 of a plurality of stator segments 104 may be assembled so as to arrange the stator segments 104 into the circular configuration shown in FIG. 1. Moreover, the core tooth portions 140 may be configured to minimize the clearance between the core tooth portions 140 and a rotor (not shown) comprising the electric motor.

As further shown in FIGS. 3-4, raised ribs 168 may be injection molded into the stator segment 104 so as to define a first channel 172, a second channel 176, a third channel 180, and a common channel 184. It is contemplated that the channels 172, 176, 180, 184 facilitate placing the winding 128 into electrical communication with a bus bar 108 (see FIG. 6). To this end, the winding start end 148 may be disposed in any one of the first, second, and third channels 172, 176, 180, and the winding terminal end 152 may be disposed in the common channel 184. Which among the channels 172, 176, 180 includes the winding start end 148 determines the phase of the electric motor in which the stator segment 104 is to participate. For example, in some embodiments, the winding start end 148 may be disposed in the first channel 172 of first-phase stator segments 104. Further, second-phase stator segments 104 may include disposing the winding start end 148 in the second channel 176 while third-phase stator segments 104 may include a winding start end 148 disposed in the third channel 180. As will be appreciated, the winding terminal ends 148 of all the stator segments 104 are to be disposed in the common channel 184.

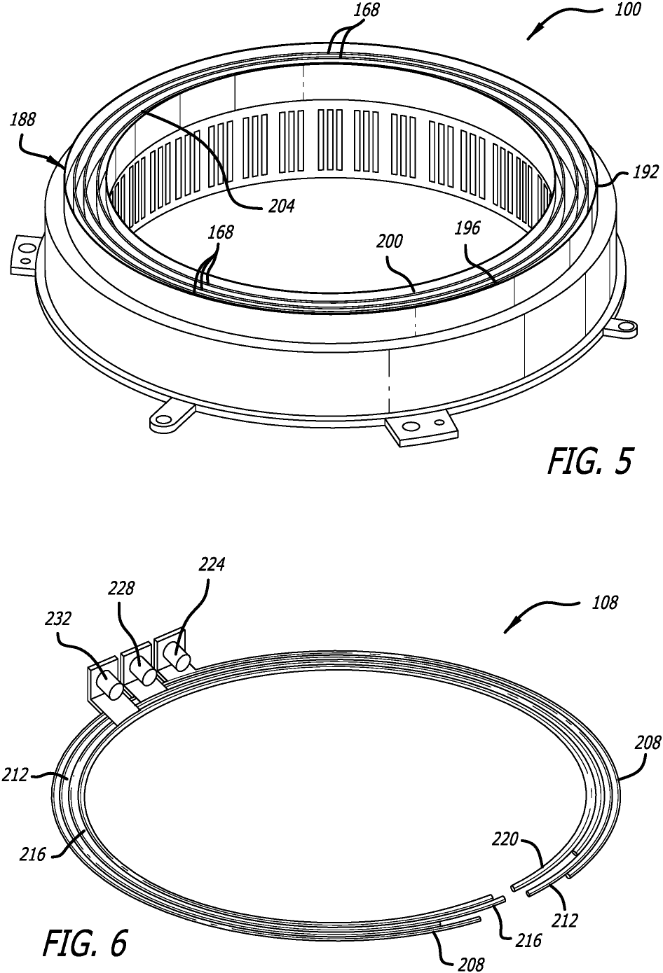

Turning, now, to FIG. 5, the channels 172, 176, 180, 184 shown in FIG. 4 are configured to form circular recesses 188 when a plurality of stator segments 104 are assembled into a circular configuration to form a stator 100. For example, in the illustrated embodiment of FIGS. 4-5, assembling the stator segments 104 to form the stator 100 causes the channels 172, 176, 180, 184 to respectively form a first circular recess 192, a second circular recess 196, a third circular recess 200, and a common circular recess 204. The circular recesses 192, 196, 200, 204 are particularly suitable for receiving annular conductors comprising the bus bar 108 shown in FIG. 6. More specifically, a first annular conductor 208 comprising the bus bar 108 may be received into the first circular recess 192, and a second annular conductor 212 comprising the bus bar 108 may be received into the second circular recess 196. Continuing, a third annular conductor 216 comprising the bus bar 108 may be received into the third circular recess 200 while a common annular conductor 220 comprising the bus bar 108 may be received into the common circular recess 204. It should be understood, therefore, that placing the bus bar 108 of FIG. 6 into the circular recesses 192, 196, 200, 204 of the stator 100 shown in FIG. 5 produces the stator 100 shown in FIG. 1. It is contemplated that, in some embodiments, the bus bar 108 may be over-molded within the circular recesses 192, 196, 200, 204 such that the bus bar is encapsulated within the segmented stator 100.

As shown in FIG. 6, the bus bar 108 includes connectors whereby electric current may be conducted to the windings 128 of the stator segments 104 by way of the annular conductors 208, 212, 216, 220. In particular, the bus bar 108 includes a first connector 224 that is in electrical communication with the first annular conductor 208, a second connector 228 in electrical communication with the second annular conductor 212, and a third connector 232 in electrical communication with the third annular conductor 216.

As will be recognized, the connectors 224, 228, 232 facilitate passing an electric current to stator segments 104 comprising different phases of the electric motor. For example, during a first phase of the electric motor, an electric current may be passed through all of the first connector 224, the first annular conductor 208, all of the windings 128 comprising first-phase stator segments 104, the common conductor 220, all of the windings 128 comprising second-phase stator segments 104, the second annular conductor 212, and the second connector 228. During a second phase of the electric motor, an electric current may be passed through all of the first connector 224, the first annular conductor 208, all of the windings 128 comprising first-phase stator segments 104, the common conductor 220, all of the windings 128 comprising third-phase stator segments 104, the third annular conductor 216, and the third connector 232. And, during a third phase of the electric motor, an electric current may be passed through all of the second connector 228, the second annular conductor 212, all of the windings 128 comprising second-phase stator segments 104, the common conductor 220, all of the windings 128 comprising third-phase stator segments 104, the third annular conductor 216, and the third connector 232.

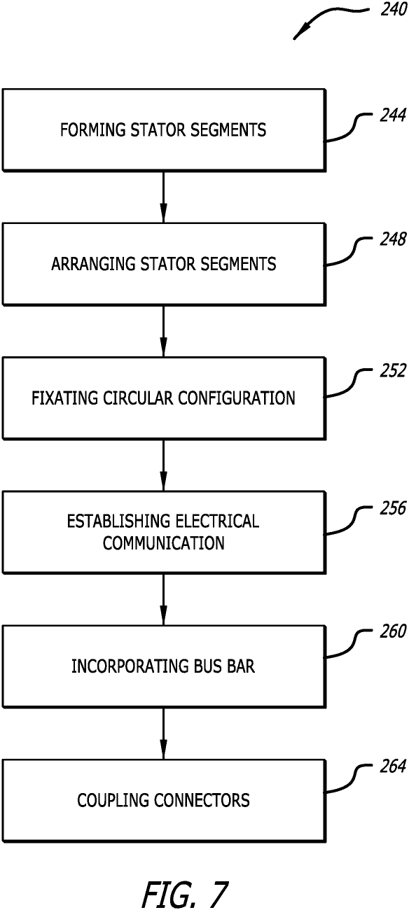

FIG. 7 is a flow chart illustrating an exemplary embodiment of a method 240 for a segmented stator, such as the segmented stator 100 shown in FIG. 1, according to the present disclosure. The method 240 begins at a step 244 wherein a plurality of stator segments 104 are formed. Forming the stator segments 104 generally includes forming a divided core 132 that includes a core back portion 136 and a core tooth portion 140. An insulator 144 may be disposed on at least the core tooth portion 140. In some embodiments, disposing the insulator 144 may include injection molding an over-molding that fixates a plurality of laminated steel plates comprising the divided core 132. Next, a winding 128 of magnet wire may be wound in a multilayer configuration onto the insulator 144. It is contemplated that, in such embodiments, the insulator 144 may comprise any suitable polymer that may be injection-molded around the section of the core tooth portion 140 that receives the winding 128. Once the winding 128 is disposed on the core tooth portion 140, the divided core 132 and the winding 128 may be encapsulated by injection molding an over-mold to fixate the winding 128 and form raised ribs 168 that define multiple channels 164 for placing a bus bar 108 into electrical communication with the winding 128.

Once the stator segments 104 are formed, the method 240 progresses to step 248 wherein a plurality of stator segments 104 may be arranged into a circular configuration suitable for operating as a segmented stator 100 of an electric motor. The segmented stator 100 may comprise any number of stator segments 104, without limitation. In some embodiments, wherein the electric motor comprises a three-phase electric motor, the segmented stator 100 may comprise 18 stator segments 104 that are assembled in step 248 such that each phase includes 6 stator segments 104. In another embodiment of a three-phase electric motor, the segmented stator 100 may comprise 27 stator segments 104 that are arranged in step 248 to includes 9 stator segments 104 in each phase. In still another embodiment of a three-phase electric motor, the segmented stator 100 may include 33 stator segments 104 that are arranged in step 248 such that each phase comprises 11 stator segments 104.

In step 252, the circular configuration of the stator segments 104 may be fixated by an exterior cylindrical portion 112. In some embodiments, fixating the cylindrical portion 112 may comprise injection-molding a polymer that fixates the stator segments 104 in the circular configuration. In some embodiments, the cylindrical portion 112 may be configured to conduct a cooling fluid around the stator segments 104. For example, the cylindrical portion 112 may, in some embodiments, include a water jacket configured to conduct heat away from the stator segments 104. Further, the cylindrical portion 112 may be provided with a plurality of mounting lugs 116 that are disposed at intervals along a circumferential direction and protrude along a radial direction with respect to the cylindrical portion 112. As will be appreciated, the mounting lugs 116 generally may include mounting holes 120 for mounting the segmented stator 100 to a base (not shown) of an electric motor.

Next, in step 256, a bus bar 108 may be placed into electrical communication with the plurality of stator segments 104 that are arranged in the circular configuration. In some embodiments, the bus bar 108 may include annular conductors 208, 212, 216, 220 that may be respectively seated in circular recesses 192, 196, 200, 204 formed by the channels 172, 176, 180, 184 disposed between raised ribs 168 comprising stator segments 104. In some embodiments, the raised ribs 168 may be injection molded into the stator segment 104, such that a winding start end 148 comprising each stator segment 104 may be disposed in any one of the first, second, and third channels 172, 176, 180, and a winding terminal end 152 may be disposed in the common channel 184.

As will be appreciated, the phase of the electric motor in which each stator segment 104 is to participate determines which of the channels 172, 176, 180 is to include the winding start end 148. Thus, step 256 may include disposing the winding start ends 148 of all first-phase stator segments 104 in the first channel 172, disposing the winding start ends 148 of all second-phase stator segments 104 in the second channel 176, and disposing the winding start ends 148 of all third-phase stator segments 104 in the third channel 180. Further, step 256 may include disposing the winding terminal ends 152 of all stator segments 104 in the common channel 184. It should be recognized, therefore, that step 256 may include establishing electrical communication between a first annular conductor 208 of the bus bar 108 and the winding start ends 148 of all first-phase stator segments 104 in the first channel 172, and establishing electrical communication between a second annular conductor 212 and the winding start ends 148 of all second-phase stator segments 104 in the second channel 176. Further, step 256 may include establishing electrical communication between a third annular conductor 216 and the winding start ends 148 of all third-phase stator segments 104 in the third channel 180, and establishing electrical communication between a common annular conductor 220 and the winding terminal ends 152 of all the stator segments 104 in the common channel 184.

Once the bus bar 108 is in electrical communication with the plurality of stator segments 104, the bus bar 108 may be incorporated into the circular configuration in step 260. In some embodiments, the bus bar 108 may include annular conductors 208, 212, 216, 220 that may be respectively seated in circular recesses 192, 196, 200, 204 formed by the channels 172, 176, 180, 184 disposed between raised ribs 168 comprising stator segments 104. Thus, the first annular conductor 208 may be seated into the first circular recess 192, a second annular conductor 212 may be seated into the second circular recess 196, and a third annular conductor 216 may be seated into the third circular recess 200 while a common annular conductor 220 comprising the bus bar 108 may be seated into the common circular recess 204. Once the bus bar 108 is seated in the circular recesses 192, 196, 200, 204, the bus bar 108 may be over-molded such that the bus bar 108 is encapsulated within the segmented stator 100.

As shown in FIG. 7, in some embodiments, the method 240 finishes at a step 264 comprising coupling connectors with the annular conductors comprising the bus bar 108. In some embodiments, for example, a first connector 224 may be coupled with the first annular conductor 208, a second connector 228 may be coupled with the second annular conductor 212, and a third connector 232 may be coupled with the third annular conductor 216. As such, the first connector 224 may be in electrical communication with the first annular conductor 208, the second connector 228 may be in electrical communication with the second annular conductor 212, and the third connector 232 may be in electrical communication with the third annular conductor 216. It should be understood that the connectors 224, 228, 232 facilitate passing an electric current to stator segments 104 comprising different phases of a three-phase electric motor.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

List of Reference Numbers

| | |
|---|---|
| 100 | segmented stator |
| 104 | over-molded stator segments |
| 108 | incorporated bus bar |
| 112 | exterior cylindrical portion |
| 116 | mounting lugs |
| 120 | mounting holes |
| 124 | wound core segment |
| 128 | winding |
| 132 | divided core |
| 136 | core back portion |
| 140 | core tooth portion |
| 144 | insulator |
| 148 | winding start end |
| 152 | winding terminal end |
| 156 | over-molded encapsulation |
| 160 | core side portions |
| 168 | raised ribs |
| 172 | first channel |
| 176 | second channel |
| 180 | third channel |
| 184 | common channel |
| 188 | circular recesses |
| 192 | first circular recess |
| 196 | second circular recess |
| 200 | third circular recess |
| 204 | common circular recess |
| 208 | first annular conductor |
| 212 | second annular conductor |
| 216 | third annular conductor |
| 220 | common annular conductor |
| 224 | first connector |
| 228 | second connector |
| 232 | third connector |
| 240 | method |
| 244 | step |
| 248 | step |
| 252 | step |
| 256 | step |
| 260 | step |
| 264 | step |

What is claimed is:

1. A segmented stator for a multi-phase electric motor, comprising:
a plurality of stator segments that are arranged into a circular configuration;
a cylindrical portion that fixates the circular configuration;
a bus bar incorporated into the stator segments; and
connectors coupled with the bus bar for passing an electric current to the stator segments.

2. The segmented stator of claim 1, wherein the cylindrical portion comprises an injection-molded polymer that is applied to retain the circular configuration of the plurality of stator segments.

3. The segmented stator of claim 1, wherein each of the plurality of stator segments comprises: a divided core that includes a core back portion and a core tooth portion; an insulator disposed on at least the core tooth portion; a winding of magnet wire disposed on the insulator; and an over-molded encapsulation of the divided core and the winding.

4. The segmented stator of claim 3, wherein the divided core comprises a solid piece of magnetically permeable material.

5. The segmented stator of claim 3, wherein the divided core comprises a plurality of laminated steel plates that are held together by way of the insulator.

6. The segmented stator of claim 5, wherein the insulator comprises an over-molding that fixates the plurality of laminated steel plates in the form of the divided core.

7. The segmented stator of claim 6, wherein the insulator comprises any suitable polymer that may be injection-molded around a section of the core tooth portion that receives the winding.

8. The segmented stator of claim 3, wherein the over-molded encapsulation is configured to cover and fixate primarily the winding and allow a winding start end and a winding terminal end to protrude from the stator segment.

9. The segmented stator of claim 8, wherein the over-molded encapsulation includes raised ribs that are injection molded into the stator segment to define multiple channels so as to facilitate placing the winding into electrical communication with a bus bar.

10. The segmented stator of claim 9, wherein the multiple channels are configured to form circular recesses when a plurality of stator segments are assembled into a circular configuration.

11. The segmented stator of claim 10, wherein the circular recesses are configured to receive annular conductors comprising the bus bar.

12. The segmented stator of claim 11, wherein the bus bar includes connectors whereby electric current may be conducted to the windings by way of the annular conductors.

13. The segmented stator of claim 11, wherein the annular conductors are over-molded within the circular recesses such that the bus bar is encapsulated within the segmented stator.

14. A stator segment for a multi-phase electric motor, comprising:
a divided core that includes a core back portion and a core tooth portion;
an insulator disposed on at least the core tooth portion;
a winding of magnet wire disposed on the insulator; and
an over-molded encapsulation of the divided core and the winding.

15. The stator segment of claim 14, wherein the insulator comprises an over-molding that fixates a plurality of laminated steel plates comprising the divided core.

16. The stator segment of claim 14, wherein the over-molded encapsulation is configured to fixate the winding and form raised ribs that define multiple channels for placing a bus bar into electrical communication with the winding.

17. A method for a segmented stator for a multi-phase electric motor, comprising:
forming a plurality of stator segments;
arranging the plurality of stator segments into a circular configuration;
fixating the circular configuration by way of a cylindrical portion;
placing a bus bar into electrical communication with the plurality of stator segments;
incorporating the bus bar into the circular configuration; and
coupling connectors with the bus bar for passing an electric current to the stator segments.

18. The method of claim 17, wherein forming the plurality of stator segment comprises: forming a divided core that includes a core back portion and a core tooth portion; disposing an insulator on at least the core tooth portion; disposing a winding of magnet wire on the insulator; and encapsulating the divided core and the winding.

19. The method of claim 18, wherein disposing the insulator includes injection molding an over-molding that fixates a plurality of laminated steel plates comprising the divided core.

20. The method of claim 18, wherein encapsulating the divided core and the winding includes injection molding an over-molded encapsulation to fixate the winding and form raised ribs that define multiple channels for placing a bus bar into electrical communication with the winding.
